(19) United States
(12) Patent Application Publication
(10) Pub. No.: US 2021/0224895 A1
(43) Pub. Date: Jul. 22, 2021

(54) SETTLEMENT MANAGEMENT SYSTEM AND SETTLEMENT MANAGEMENT METHOD

(71) Applicant: HITACHI, LTD., Tokyo (JP)

(72) Inventor: Takashi YAMAGISHI, Tokyo (JP)

(21) Appl. No.: 17/053,382

(22) PCT Filed: Feb. 13, 2019
(86) PCT No.: PCT/JP2019/004971

§ 371 Date: Nov. 6, 2020

(30) Foreign Application Priority Data
May 8, 2018 (JP) 2018-089886

(51) Int. Cl. G06Q 40/02; G06Q 10/10; G06Q 20/12; G06Q 20/40; G06Q 20/38; G06F 16/27

(52) U.S. Cl. CPC G06Q 40/02; G06Q 10/10; G06Q 20/127; G06F 16/27; G06Q 20/407; G06Q 20/389; G06Q 20/4037

(57) ABSTRACT

A settlement management system includes: a storage device that stores, for each contractor, information on contract contents in a period in which the contractor is alive and in a period after decease of the contractor; and a computation device that executes calculating a total service usage fee of a predetermined contractor, based on a length of a contract period and a service usage fee unit price in each of the periods indicated in the contract contents, balance inquiry for a personal account of the contractor, debiting an amount of money equal to the total service usage fee when balance inquiry for a personal account of the contractor and a balance of the personal account is an amount of money large enough to settle the total service usage fee, settling a service usage fee based on the service usage fee unit price in the period in which the contractor is alive.

### TECHNICAL FIELD

The present invention relates to a settlement management system and a settlement management method and specifically relates to a technique that allows a process of settling a fee of a continuous service that substantially starts to be provided after decease of a contractor to be performed in a form considering needs and convenience of stakeholders and the like.

### BACKGROUND ART

Various methods of settling a service usage fee are proposed such as a method in which a remaining debt of an event contracted by a contractor of a certain service while the contractor is alive is settled after the decease of the contractor. As one of such methods that is generally and widely known, there is a method in which a remaining debt of a home mortgage is settled by using insurance money of a group credit life insurance.

As a conventional technique relating to such settlement, there is proposed, for example, an insurance company terminal (see Patent Literature 1) including a communication unit that communicates with a sales company terminal; a storage unit that stores an amount of insurance money to be settled when a user deceases; a user information updating unit that obtains a fee of a product or a service purchased by the user from the sales company terminal via the communication unit as a purchase fee and stores the purchase fee in the storage unit; a settlement processing unit that subtracts the purchase fee from the amount of insurance money stored in the storage unit.

Moreover, there is also proposed, for example, an information processing reservation and automatic execution system for a personal client (see Patent Literature 2) that executes information processing on remaining data or unexecuted data that relates to the personal client and that is present in an individual specified system and are left therein after the personal client deceases or receives a certification of a long-term care need. The information processing reservation and automatic execution system for a personal client includes a storage device, reception means, execution means, and transmission means and is capable of communicating with a personal information management system of an institution having the personal information relating to the personal client by being in contractual relationships with the personal client, specifically, a financial institution including an insurance company, a bank, a Shinkin bank, a credit union, a labor bank, a brokerage company, and Japan Agricultural Cooperatives, an agent of these institutions, a telecommunication carrier, a real estate management company, a transportation company, a company relating to funerals, a company relating to caregiving, a hospital, a school, a public office, a corporation handling personal information, or a corporation receiving requests from such corporations and instructions (hereinafter, such an institution is referred to as “institution having the personal information of the personal client”). The storage device stores at least one of “information identifying the personal client”, “information specifying the individual specified system”, “specification ID and password” relating to authorization performed when the personal client accesses the individual specified system”, “request to execute certain information processing relating to data remaining in the individual specified system” and one or more “program that executes the certain information processing for the individual specified system” as “pre-request contents” sent from the personal client and relating to the information processing on the remaining data of the personal client present in the individual specified system. When the reception means receives or receives an input of at least one of the information identifying the personal client, decease information or long-term care need certification information relating to the personal client, and information proving a sender by means of direct input from the personal information management system or an information terminal of the institution having the personal information of the personal client, the execution means extracts the “information specifying the individual specified system”, the “request to execute the certain information processing for the individual specified system”, the “specification ID and password”, and the “program that executes the certain information processing for the individual specified system” relating to the information identifying the personal client received by the reception means, accesses the individual specified system from the transmission means via a network such as the Internet, gains access permission such as personal authentication by using the “specification ID and password”, and then operates and executes the “program that executes the certain information processing for the individual specified system”.

Moreover, there is proposed, for example, a message storage apparatus (see Patent Literature 3) that stores a message and supports collection of a message storage fee for the stored message as a service in which contents contracted while the contractor is alive are executed after their decease. The message storage apparatus includes: a storage unit that stores, for each insurance contractor, billing amount information storing a billing amount that is an amount of money for which time of billing has come in the message storage fee and that stores, for each insurance contractor, collateral set amount information storing a debit account from which the message storage fee is debited, a balance of the debit account, a collateral account whose free encashment can be prohibited when the message storage fee cannot be debited, a balance of the collateral account, and a balance of the collateral account at which the encashment is actually prohibited; and a control unit that determines the insurance contractor from who the bill is to be collected by referring to the billing amount information when the time for the billing comes, determines the debit account of the determined insurance contractor by referring to the collateral set amount information, takes away the billing amount from the balance of the determined debit account and then stores this operation, and, when the billing amount cannot be taken away from the balance of the determined debit account, determines the collateral account of the determined insurance contractor by referring to the collateral set amount information and stores part of or the entire balance of the determined collateral account as a balance whose encashment is actually prohibited in the balance of the collateral account.

### CITATION LIST

### Patent Literature

[PTL 1] Japanese Patent Application Publication No. 2011-118630

[PTL 2] Japanese Patent Application Publication No. 2015-149048

[PTL 3] Japanese Patent Application Publication No. 2013-120513

### SUMMARY OF INVENTION

### Technical Problem

Services that are targets of the conventional techniques are within a category of services of giving notices directed to stakeholders with the decease of the contractor and performing a remaining debt process for services used while the contractor is alive.

Meanwhile, there is also assumed a service in which a video or a three-dimensional avatar of the dead contractor is continuously provided to the bereaved, the stakeholders, or the like based on technologies of artificial intelligence, virtual reality, and the like that are rapidly advancing in recent years. When the conventional techniques are attempted to be applied to such services, the conditions for providing the services greatly vary and the conventional techniques cannot deal with a situation where substantial start of a service is triggered by the decease of the contractor. Hence, appropriate settlement of a service usage fee cannot be performed.

Accordingly, an object of the present invention is to provide a technique that allows a process of settling a fee of a continuous service that substantially starts to be provided after decease of a contractor to be performed in a form considering needs and convenience of stakeholders and the like.

### Solution to Problem

A settlement management system to solve the above object comprising: a storage device that stores, for each of contractors of a predetermined service, information on contract contents of the predetermined service in a period in which the contractor is alive and in a period after decease of the contractor; a computation device that executes a process of calculating a total service usage fee for a case where a service usage period after decease of a predetermined contractor from a current time point or a predetermined time point is the longest, based on a length of a contract period and a service usage fee unit price in each of the periods indicated in the information on the contract contents, a predetermined process of balance inquiry for a personal account of the predetermined contractor, a process of debiting an amount of money equal to the total service usage fee from the personal account to a separate account when a balance of the personal account is an amount of money large enough to settle the total service usage fee, a process of settling a service usage fee based on the service usage fee unit price in the period in which the predetermined contractor is alive, from the separate account every predetermined period while the predetermined contractor is alive, a process of obtaining decease information of the predetermined contractor from a predetermined apparatus and calculating a service usage fee incurred for a remaining period in the period after the decease of the predetermined contractor based on a date of decease indicated in the decease information, the length of contract period, and the service usage fee unit price in the period after the decease, and a process of settling a service usage fee calculated for the remaining period from the separate account and refunding money left after settlement of the total service usage fee to the personal account.

Further a settlement management method of the present disclosure in which an information processing system including a storage device that stores, for each of contractors of a predetermined service, information on contract contents of the predetermined service in a period in which the contractor is alive and in a period after decease of the contractor executes processes comprising: a process of calculating a total service usage fee for a case where a service usage period after decease of a predetermined contractor from a current time point or a predetermined time point is the longest, based on a length of a contract period and a service usage fee unit price in each of the periods indicated in the information on the contract contents; a predetermined process of balance inquiry for a personal account of the predetermined contractor; a process of debiting an amount of money equal to the total service usage fee from the personal account to a separate account when a balance of the personal account is an amount of money large enough to settle the total service usage fee; a process of settling a service usage fee based on the service usage fee unit price in the period in which the predetermined contractor is alive, from the separate account every predetermined period while the predetermined contractor is alive; a process of obtaining decease information of the predetermined contractor from a predetermined apparatus and calculating a service usage fee incurred for a remaining period in the period after the decease of the predetermined contractor based on a date of decease indicated in the decease information, the length of the contract period, and the service usage fee unit price in the period after the decease; and a process of settling a service usage fee calculated for the remaining period from the separate account and refunding money left after settlement of the total service usage fee to the personal account.

### Advantageous Effects of Invention

The present invention allows a process of settling a fee of a continuous service that substantially starts to be provided after decease of a contractor to be performed in a form considering needs and convenience of stakeholders and the like.

### BRIEF DESCRIPTION OF DRAWINGS

FIG. 1 is a diagram illustrating a network configuration example including a settlement management system in an embodiment.

FIG. 2 is a diagram illustrating a hardware configuration example of a settlement management apparatus in the embodiment.

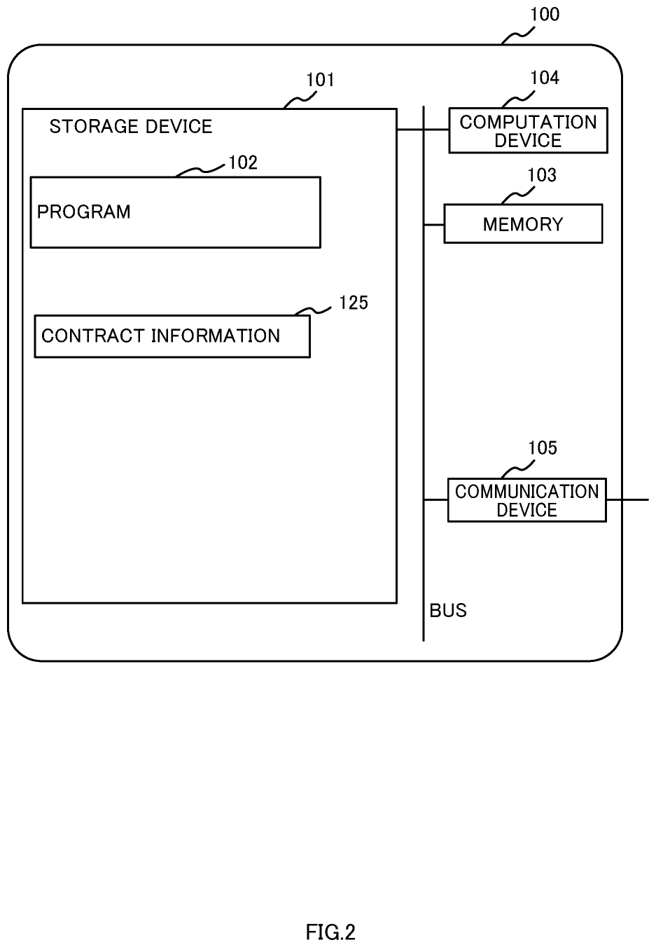

FIG. 3 is a diagram illustrating a hardware configuration example of a service provider apparatus in the embodiment.

FIG. 4 is a diagram illustrating a data configuration example of contract information in the embodiment.

FIG. 5 is a diagram illustrating a data configuration example of payment information in the embodiment.

FIG. 6 is a diagram illustrating a data configuration example of account management information in the embodiment.

FIG. 7 is a diagram illustrating a flow example of a settlement management method in the embodiment.

FIG. 8 is a diagram illustrating a notification example in the embodiment.

FIG. 9 is a diagram illustrating a configuration example of a distributed ledger network in another embodiment.

FIG. 10 is a diagram illustrating a hardware configuration example of a settlement management apparatus in the other embodiment.

### DESCRIPTION OF EMBODIMENTS

### —Network Configuration—

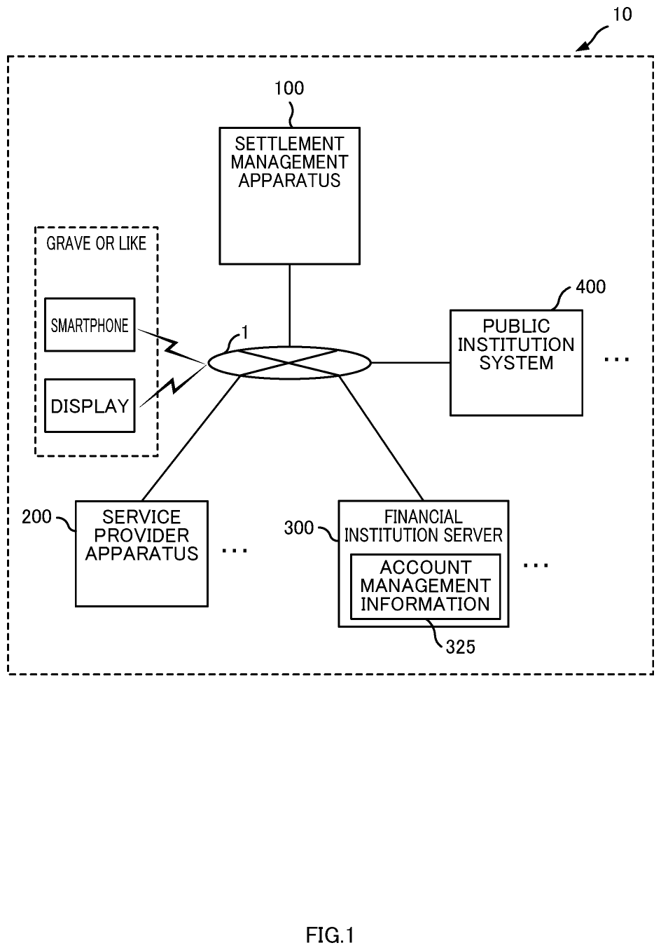

An embodiment of the present invention is described below in detail by using the drawings. FIG. 1 is a network configuration diagram including a settlement management system 10 of the embodiment.

The settlement management system 10 illustrated in the network configuration of FIG. 1 is a computer system that allows a process of settling a usage fee of a continuous service that substantially starts to be provided after the decease of a contractor to be performed in a form considering needs and convenience of stakeholders and the like.

As a specific example of the aforementioned continuous service, a service in which, every time the bereaved of the dead contractor visits a grave, a charnel house, or the like of the contractor, this visit is detected and a video or a three-dimensional avatar of the contractor is distributed and displayed on a smartphone 50 of the bereaved or displayed on a display 60 installed in the aforementioned grave or the like can be assumed. This service is continuously provided from the decease of the contractor to expiration of a period defined in contract contents (agreed by the contractor while the contractor is alive). As a matter of course, this service is merely an example and various other services are assumable.

The settlement management system 10 as described above includes at least a settlement management apparatus 100 and a service provider apparatus 200 among the settlement management apparatus 100, the service provider apparatus 200, a financial institution server 300, and a public institution system 400.

Among these apparatuses, the settlement management apparatus 100 is an information processing apparatus mainly forming the settlement management system 10 of the embodiment. An operating entity of the settlement management apparatus 100 can be assumed to be, for example, a broker who mediates various electronic processes that happen between a service provider who provides the aforementioned continuous service and the contractor who desires to use the continuous service and make a contract for the continuous service.

The service provider apparatus 200 is an information processing apparatus of the service provider who provides the aforementioned continuous service to the contractor. The service provider concludes a service providing contract with the aforementioned contractor, manages information on the contents of this contract (contract information 225 to be described later), and manages a history (payment information 226 to be described later) of collecting, from the contractor, a service usage fee whose amount is defined in the contents of the contract.

The financial institution server 300 is a server apparatus of a financial institution that manages a personal account of the aforementioned contractor and a separate account. An account system host is assumable as a specific example of the financial institution server 300. The financial institution server 300 receives a settlement request from the settlement management apparatus 100 or the service provider apparatus 200 via, for example, an Internet banking system and performs accounting system processes such as fund transfer from the personal account to the separate account, fund transfer of the service usage fee from the separate account to an account of the service provider, and refund of a balance in the separate account after the settlement to the personal account based on the account information (account management information 325 to be described later) managed by the financial institution server 300 itself. Note that, after the financial institution server 300 completes the aforementioned accounting system processes associated with execution of the settlement management method of the embodiment, the financial institution server 300 executes a process of freezing the personal account of the contractor.

The public institution system 400 is assumed to be, for example, a system operated by a hospital, an autonomous body of an area where the aforementioned contractor is living, or the like. More specifically, the public institution system 400 is a system such as a system that updates family register information of residents with birth or decease of the residents or a system that notifies facts of the aforementioned birth and decease to the autonomous body.

### —Hardware Configuration—

Hardware configurations of the apparatuses forming the settlement management system 10 of the embodiment are as follows.

First, the settlement management apparatus 100 of the embodiment includes a storage device 101 formed of an appropriate non-volatile storage element such as a SSD (solid state drive) or a hard disk drive, a memory 103 formed of a volatile storage element such as a RAM, a computation device 104 such as a CPU that performs various determination, computation, and control processes and also performs overall control of the apparatus by, for example, loading a program 102 held in the storage device 101 onto the memory 103 and executing it, and a communication device 105 that is coupled to a network 1 and that handles a communication process with the other apparatuses such as the service provider apparatus 200, the financial intuition service 300, and the public institution system 400.

Note that at least contract information 125 is stored in the storage device 101 in addition to the program 102 for implementing functions necessary for the apparatus forming the settlement management system 10 of the embodiment. Details of the contract information 125 are described later.

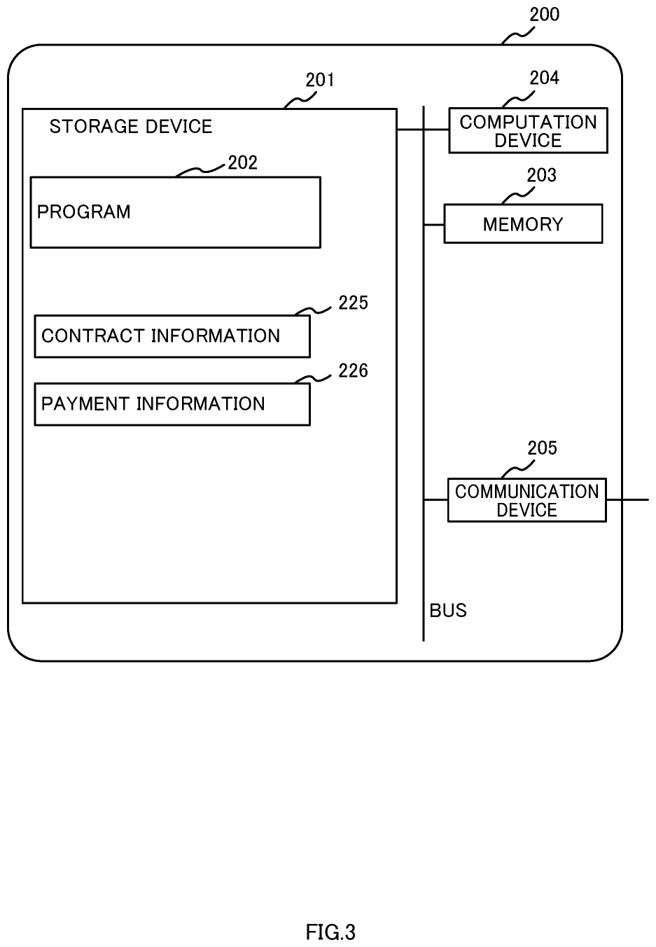

FIG. 3 illustrates a hardware configuration example of the service provider apparatus 200 in the embodiment. The service provider apparatus 200 in the embodiment includes a storage device 201 formed of an appropriate non-volatile storage element such as a SSD (solid state drive) or a hard disk drive, a memory 203 formed of a volatile storage element such as a RAM, a computation device 204 such as a CPU that performs various determination, computation, and control processes and also performs overall control of the apparatus by, for example, loading a program 202 held in the storage device 201 onto the memory 203 and executing it, and a communication device 205 that is coupled to the network 1 and that handles a communication process with the other apparatuses such as the settlement management apparatus 100, the financial intuition service 300, and the public institution system 400.

Note that at least contract information 225 and payment information 226 are stored in the storage device 201 in addition to the program 202 for implementing functions necessary for the apparatus forming the settlement management system 10 of the embodiment. Details of the contract information 225 and the payment information 226 are described later.

### —Data Configuration Example—

Next, information used by the apparatuses forming the settlement management system 10 of the embodiment is described.

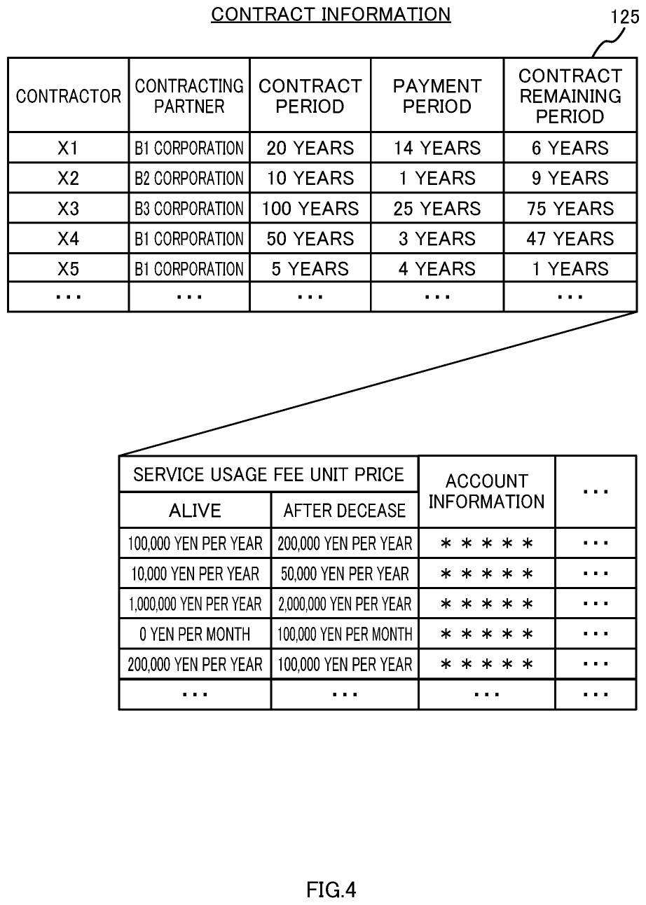

FIG. 4 illustrates a data configuration example of the contract information 125 in the embodiment. The contract information 125 (and the contract information 225) illustrated in FIG. 4 is a database storing information on the contents of the contract that the contractor concludes with the service provider (at the mediation of the broker) to receive the aforementioned continuous service.

Although the contract information 125 held by the settlement management apparatus 100 is described as an example herein, the service provider apparatus 200 also holds the same contract information 125 as the contract information 225.

The data structure of the contract information 125 is a collection of records in each of which a contractor ID uniquely identifying the contractor is used as a key and pieces of data such as a contracting partner (identification information of the service provider) with which the contractor concluded a contract, a contract period, a payment term, a contract remaining period, a service usage fee unit price, and account information are associated with one another.

Among these pieces of data, the “contract period” is a value indicating the length of a total contract period that is a sum of a period in which the contractor is alive and a period after the decease of the contractor. Note that the period in which the contractor is alive and the period after the decease are not confirmed until the decease of the contractor and are totally unknown values at the point of the conclusion of the contract. Moreover, the value of the “contract period” is an arbitrary value that the contractor desires.

The “payment term” is a value indicating a lapse period in which the contractor has paid the service usage fee to date as a result of the conclusion of the contract. For example, when the contractor has paid the service usage fee for 14 years, the “payment term” is 14 years.

The “contract remaining period” is a value indicating the length of a remaining period obtained by subtracting the “payment term” from the “contract period” described above. For example, when the contractor has paid the service usage fee for 14 years in the contract with the “contract period” of 20 years, the “contract remaining period” is 6 years.

The “service usage fee unit price” is a value indicating a unit price of the service usage fee in each of the period in which the contractor is alive and the period after the decease described above. For example, the service usage fee unit price in the period in which the contractor is alive is defined as “100,000 yen per year” and the service usage fee unit price in the period after the decease is defined as “200,000 yen per year” or the like. Note that these values of the “service usage fee unit price” correspond to an amount of money and a unit period agreed between the contractor and the service provider and basically reflect the request of the contractor. The “account information” is information on an account specified by the contractor as a debit account for the service usage fee and includes values such as a branch number, a type, and an account number.

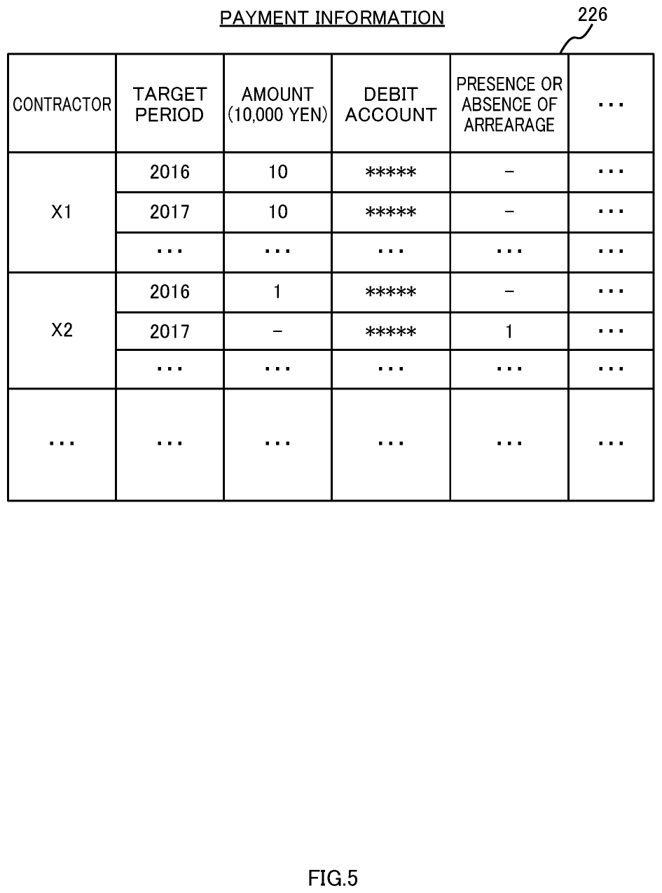

FIG. 5 illustrates a data configuration example of the payment information 226 in the embodiment. The payment information 226 in the embodiment is a database storing information on the service usage fee collected by the service provider from the contractor.

The data structure of the payment information 226 is a collection of records in each of which the contractor ID uniquely identifying the contractor is used as a key and pieces of data such as a target period in which the contractor has paid the service usage fee to the service provider, an amount of money, a debit account, and presence or absence of arrearage are associated with one another. Note that, in the example of FIG. 5, a mode in which “1” is set in a field of presence or absence of arrearage for a term in which the service usage fee is unpaid is illustrated as an example.

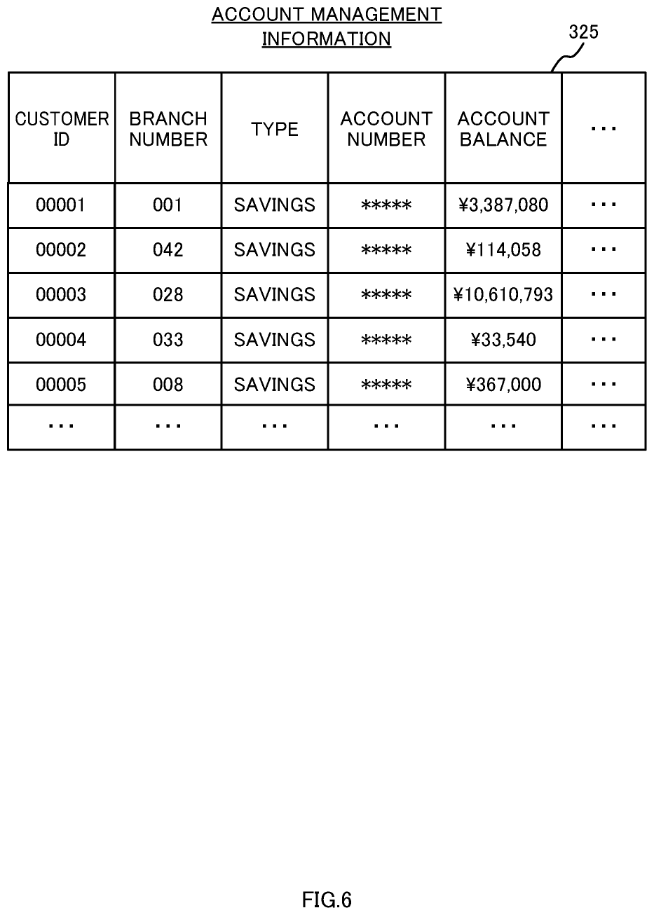

FIG. 6 illustrates a data configuration example of account management information 325 in the embodiment. The account management information 325 is managed by the financial institution server 300 and is a database storing the account information of each customer of the financial institution. Note that the aforementioned contractor is a customer of this financial institution and has a personal account. Moreover, the account management information 325 is assumed to also include information on the separate account.

The data structure of the account management information 325 is a collection of records in each of which a customer ID being identification information of the customer is used as a key and pieces of data such as a branch number, a type, an account number, and an account balance of the personal account of the customer are associated with one another.

### —Flow Example—

Actual procedures of the settlement management method in the embodiment are described below based on the drawings. Programs loaded onto the memories or the like and executed by the apparatuses forming the settlement management system 10 implement various operations corresponding to the settlement management method described below. Moreover, these programs include codes for performing the various operations described below.

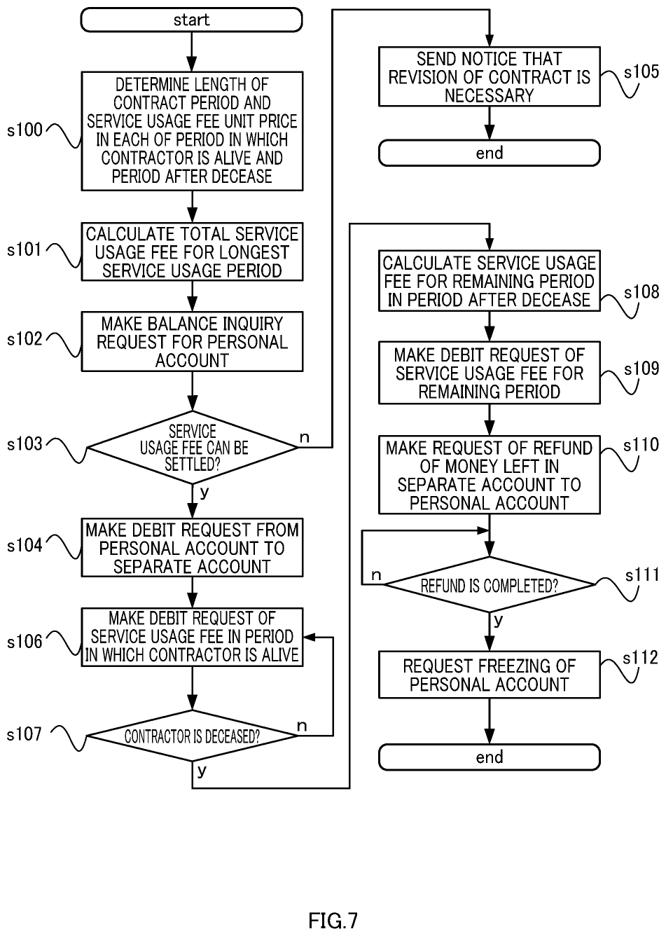

FIG. 7 is a diagram illustrating a flow example of the settlement management method in the embodiment. In this example, the aforementioned settlement management apparatus 100 first refers to the contract information 125 of a certain contractor and determines values of the length of the contract period and the service usage fee unit price in each of the period in which the contractor is alive and the period after the decease defined in the contract information 125 (s100).

For example, the settlement management apparatus 100 determines values such as the service usage fee unit price in the period in which the contractor is alive “100,000 yen per year” and the service usage fee unit price in the period after the decease “200,000 yen per year” as the values of the “service usage fee unit price” and determines a value such as “20 years” in the field of “contract period” as the length of the contract period, from the record relating to the contractor among the records in the contract information 125.

Note that the contractor that is a processing target in s100 is assumed to be, for example, a new contractor whose information is stored in the contract information 125 (contract information 225). In this case, the settlement management apparatus 100 is assumed to refer to the contract information 125 at fixed time intervals and detect registration of a new record as emergence of a new contractor. More specifically, the contract information 125 in the settlement management apparatus 100 is configured to be updated with updating of the contract information 225 by the service provider apparatus 200 and the settlement management apparatus 100 is assumed to execute s100 in response to occurrence of this updating event.

Next, the settlement management apparatus 100 calculates a total service usage fee for the case where the contractor deceases and a service usage period after the decease from the current time point or a predetermined time point (for example, a contract execution start date specified by the contractor in advance) is the longest, based on the values obtained in s100, that is the length of the contract period and the service usage fee unit price in each of the period in which the contractor is alive and the period after the decease (s101).

For example, in the specific example described above, when the contractor deceases just after the conclusion of the contract, the entire period of the contract period “20 years” is the period “after the decease”. Accordingly, the “contract period” corresponds to the longest service usage period as the “period after the decease”. Thus, the settlement management apparatus 100 multiplies the “20 years” that is the longest service usage period by the service usage fee unit price “200,000 per year” in the period after the decease and calculates 4,000,000 yen as the total service usage fee.

Moreover, the settlement management apparatus 100 requests the financial institution server 300 to make a balance inquiry for the personal account of the aforementioned contractor (s102). The financial institution server 300 receives this request, refers to the information on the contractor in the account management information 325, and sends back a value of the balance.

Then, the settlement management apparatus 100 compares the balance of the personal account obtained from the financial institution server 300 in response to the aforementioned request with the total service usage fee calculated in s101 and determines whether the total service usage fee can be settled by the balance of the personal account (s103).

When the settlement management apparatus 100 finds out that the settlement is possible as a result of the aforementioned determination (S103: y), the settlement management apparatus 100 requests the financial institution server 300 to perform fund transfer, that is debit an amount of money equal to the aforementioned total service usage fee from the personal account to the predetermined separate account (s104). Meanwhile, the financial institution server 300 receives this request, executes a predetermined debit process, updates the account information of the contractor in the account management information 325, and sends back a result of the debit process to the settlement management apparatus 100.

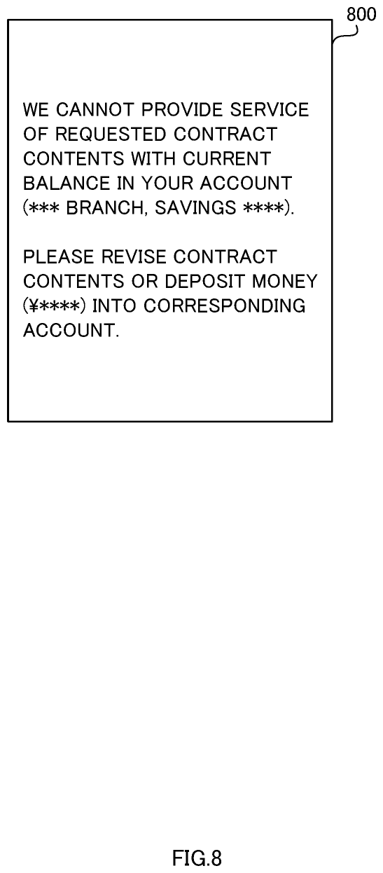

On the other hand, when the settlement management apparatus 100 finds out that the settlement is not possible as a result of the aforementioned determination (S103: n), the settlement management apparatus 100 sends a message indicating that the settlement is not possible and the contract thus needs to be revised (see message 800 in FIG. 8) to, for example, a predetermined terminal of the contractor (appropriate notification destination such as e-mail address thereof is known in advance) (s105) and terminates the process.

Note that, before the execution of s104 described above, the settlement management apparatus 100 may also obtain information on a deposit-withdrawal history of the personal account from the financial institution server 300 in addition to the account balance of the personal account and perform the predetermined determination.

In this case, the settlement management apparatus 100 performs determination for at least one of a relationship between the total service usage fee and the account balance of the personal account and a relationship between the total service usage fee and a decrease trend of the account balance of the personal account and detects a situation where there is a risk of the balance of the personal account falling below the total service usage fee.

For example, the settlement management apparatus 100 determines whether the account balance of the personal account falls below 110% of the total service usage fee and determines whether a balance decrease rate (calculable by adding up changes of deposit and withdrawal indicated in the deposit-withdrawal history) in the latest unit period (for example, one month) reaches a predetermined reference (for example, 30% per week) and the balance is likely to fall below the total service usage fee before a predetermined date (for example, a date two weeks from now) if the balance decrease rate remains at this level. When the settlement management apparatus 100 gives a negative determination result for at least one of the determinations, that is, determines that there is a risk of the balance of the personal account falling below the total service usage fee, the settlement management apparatus 100 performs the fund transfer of an amount money equal to the total service usage fee from the personal account to the separate account (sends the aforementioned debit request to the financial institution server 300).

Returning to the description of processes from s104 described above, when the settlement management apparatus 100 obtains a debit success result from the financial institution server 300 in response to the execution of s104, the settlement management apparatus 100 recognizes that the contractor can actually fulfill the contract and requests the financial institution server 300 to debit the service usage fee for the contractor based on the service usage fee unit price in the period in which the contractor is alive, every time a predetermined period such as one month elapses (s106). The debit request is a request of a process of debiting an amount of money equal to the service usage fee from the aforementioned separate account holding the total service usage fee for the contractor to a predetermined account of the service provider providing the service.

The financial institution server 300 receiving this request transfers an amount of money equal to the service usage fee from the separate account to the account of the service provider and sends back the result of this operation to the settlement management apparatus 100.

Note that the service provider apparatus 200 of the service provider detects this fund transfer, that is a deposit to the account of the service provider and reflects the content of the fund transfer in the payment information 226. In this case, the service provider apparatus 200 periodically refers to the deposit-withdrawal history of the account of the service provider by using the Internet banking service of the financial institution. When there is a deposit from the separate account relating to the aforementioned contractor, the service provider apparatus 200 recognizes the deposit as an event of collecting the service usage fee from the contractor and stores information on this deposit in the payment information 226.

The settlement management apparatus 100 periodically executes s106 for the aforementioned contractor until it receives decease information from the public institution system 400 (s107: n).

When the settlement management apparatus 100 receives the decease information of the aforementioned contractor from the public institution system 400 (s107: y), the settlement management apparatus 100 calculates the service usage fee that is incurred for a remaining period in the period after the decease, based on the date of decease of the contractor indicated in the decease information, the service usage fee unit price in the period after the decease of the contractor, and the length of the contract period (s108).

For example, the settlement management apparatus 100 multiplies a value “14 years” in the field “contract remaining period” of the contract information 125 by the service usage fee unit price in the period after the decease of the contractor “200,000 yen per year” and calculates “2,800,000 yen” as the service usage fee incurred for the remaining period.

Next, the settlement management apparatus 100 requests the financial institution server 300 to debit the service usage fee calculated for the remaining period in S108 (s109). The debit request is a request of a process of debiting an amount of money equal to the service usage fee from the aforementioned separate account holding the total service usage fee for the contractor to the predetermined account of the service provider providing the service.

The financial institution server 300 receiving this request transfers an amount of money equal to the aforementioned service usage fee calculated for the remaining period from the separate account to the account of the service provider and sends back the result of this operation to the settlement management apparatus 100.

Moreover, the settlement management apparatus 100 determines the balance of the separate account after the fund transfer, that is the settlement performed as a result of the debit request in s109, as money left after payment of the total service usage fee and requests the financial institution server 300 to refund the money left after the payment from the separate account to the personal account of the aforementioned contractor (s110).

The financial institution server 300 receiving this request transfers the amount of money left in the separate account described above from the separate account to the personal account and sends back the result of this operation to the settlement management apparatus 100.

Next, completion of the aforementioned process of refunding the money in s110 (sill: y) triggers the settlement management apparatus 100 to give a notice of a request or permission to freeze the personal account to the financial institution server 300 managing the personal account (s112) and the process is terminated.

### Other Embodiments

A mode in which the settlement management apparatus 100, the service provider apparatus 200, the financial institution server 300, the public institution system 400, and the like included in the network 1 of the aforementioned embodiment are nodes of a distributed ledger network 5 is also assumable.

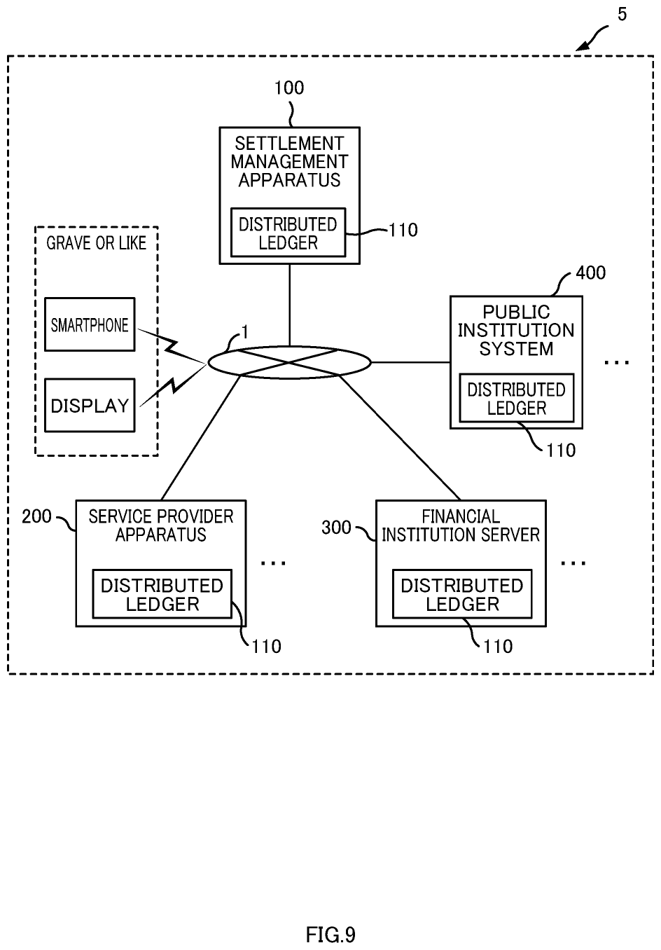

FIG. 9 illustrates a configuration example of the distributed ledger network 5 in the embodiment. As illustrated in FIG. 9, the settlement management apparatus 100, the service provider apparatus 200, the financial institution server 300, and the public institution system 400 that are nodes of the distributed ledger network 5 each hold a distributed ledger 110 in the storage device thereof.

The distributed ledger 110 is a so-called blockchain and is a series of blocks in which transactions issued by any of the nodes in the distributed ledger network 5 are grouped at fixed time intervals. Note that a confirmation process for the transactions is performed in work of calculating a specific hash value called proof of work through validity determination performed by a predetermined node called miner. The transactions confirmed herein are grouped into one block and are recorded in the blockchain, that is the aforementioned distributed ledger 110.

Accordingly, when the aforementioned apparatuses forming the settlement management system 10 are set as nodes, the transaction is issued every time any of the aforementioned steps s100 to sill is executed in the corresponding node, and is broadcasted in the network 1. Moreover, predetermined consensus formation such as the aforementioned validity determination is performed for this transaction and the transaction is then stored in the distributed ledger 110 of each apparatus.

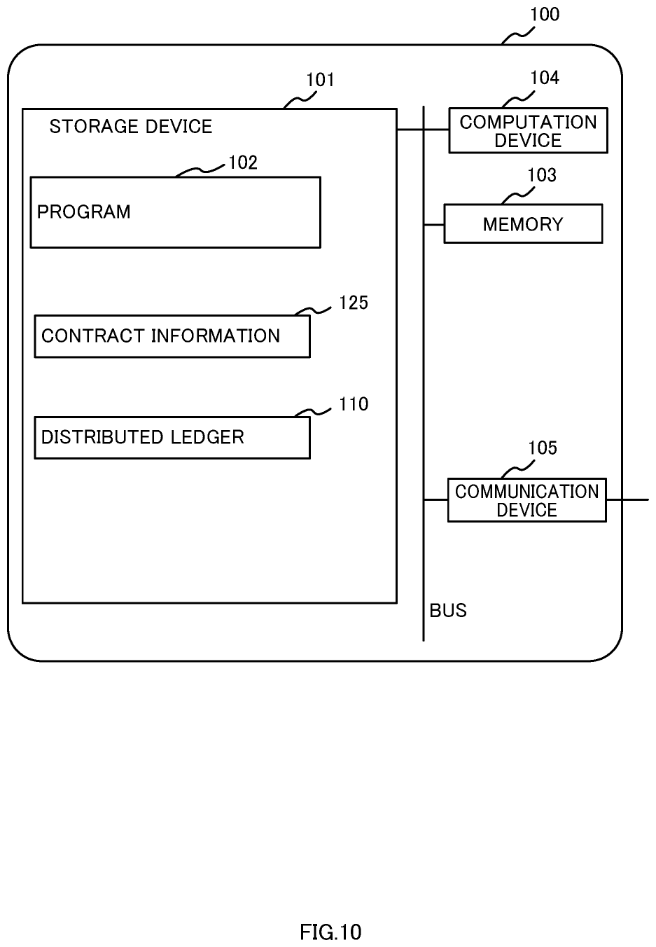

A hardware configuration example of the settlement management apparatus 100 among these nodes is illustrated in FIG. 10 as a typical example of these nodes. As illustrated in FIG. 10, the settlement management apparatus 100 holds the distributed ledger 110 in the storage device 101. Although not particularly illustrated, each node is assumed to preliminarily have general functions corresponding to the so-called distributed ledger technology such as issuing of the transaction, the aforementioned consensus formation, and addition of the transaction to the block.

Employing such distributed ledger technology has, for example, the following advantages. Manipulation can be made substantially impossible by grouping multiple transactions issued by the nodes into a block, recording the blocks linked to one another in the distributed ledger 110, and subjecting the series of blocks to hash calculation. Moreover, all participants (all operators of the nodes) can check the transactions by sharing the same ledger data in the distributed ledger 110.

Under such assumption, for example, each node can receive a transaction relating to information on the decease of the contractor issued by public institution system 400, store the transaction in the distributed ledger 110 after forming predetermined consensus in the distributed ledger network, and perform a process to be performed by the node itself (any of processes of s100 to sill or a process to be executed in relation to these steps) without being affected by processing statuses of the other nodes and the like.

Specifically, the transaction of the decease of the contractor can trigger each of the nodes forming the distributed ledger network to execute the process to be performed by the node itself and this improves the processing efficiency as a whole and reduces various costs required for information processing by the stakeholders.

Although the best mode and the like for carrying out the present invention have been specifically described above, the present invention is not limited to this mode and various changes can be made within a scope not departing from the spirit of the present invention.

According to the embodiment, it is possible to continuously collect and settle the service usage fee (lower than the service usage fee in the period after the decease) while the contractor is alive and settle the fee of the service that substantially starts with the decease of the contractor, by using a settlement fund secured in the separate account at the time of the conclusion of the contract as a resource. Moreover, control can be performed such that the fee is settled before the process of freezing the personal account, and allow the service provider to swiftly and surely collect the service usage fee.

Specifically, the process of settling the usage fee of the continuous service that substantially starts to be provided after the decease of the contractor can be performed in a form considering the needs and convenience of the stakeholders and the like.

At least the following matters are apparent from the statements in this description. Specifically, the settlement management system of the embodiment may be such that the completion of the process of refunding the money triggers the computation device to further give the notice of the request or permission to freeze the personal account to the predetermined apparatus in the financial institution managing the personal account.

This allows the service provider to surely and swiftly collect the service usage fee. Then, the process of settling the usage fee of the continuous service that substantially starts to be provided after the decease of the contractor can be performed in a form further considering the needs and convenience of the stakeholders and the like.

The settlement management system of the embodiment may be such that the computation device executes the process of obtaining the information on the balance or the deposit-withdrawal history of the personal account from the predetermined apparatus of the financial institution managing the personal account and debiting an amount of money equal to the total service usage fee when the balance or the deposit-withdrawal history satisfies a predetermined criterion.

This enables detection of a situation in which there is a risk of the balance of the personal account falling below the total service usage fee such as, for example, “the balance decrease rate considering a deposit-withdrawal tendency in a certain period reaches a predetermined reference and the balance is likely to fall below the total service usage fee before a predetermined date if the balance decrease rate remains at this level” or “the account balance falls below 110% of the total service usage fee” and fund transfer of the total service usage fee from the personal account to the separate account can be performed before this risk becomes reality.

The contractor can thereby have convenience of managing and using money, being the settlement resource of the service usage fee, in his or her personal account at his or her will as before. Meanwhile, the service provider can improve the satisfaction of the contractor by providing the aforementioned convenience and surely collect the service usage fee by timely securing the settlement resource. Moreover, the financial institution managing the personal account can smoothly complete the fund transfer and the service usage fee settlement before the account freezing process performed with the decease of the contractor and improve businesses efficiency. Then, the process of settling the usage fee of the continuous service that substantially starts to be provided after the decease of the contractor can be performed in a form further considering the needs and convenience of the stakeholders and the like.

Moreover, the settlement management system of the embodiment may be such that: execution entities of at least the process of calculating the service usage fee incurred for the remaining period in the period after the decease and the process of settling the service usage fee calculated for the remaining period and refunding the money among the aforementioned processes are different apparatuses and the apparatuses that are the execution entities form the distributed ledger network together with the predetermined apparatus that is the source of the decease information; and the computation device of each of the apparatuses that are the execution entities executes the process of receiving the transaction relating to the decease information issued by the predetermined apparatus, the process of storing the transaction in the distributed ledger after the predetermined consensus formation in the distributed ledger network, and either the process of calculating the service usage fee incurred for the remaining period or the process of settling the service usage fee calculated for the remaining period and refunding the money that is to be handled by the computation device itself.

The transaction of the decease of the contractor can thereby trigger each of the apparatuses forming the aforementioned distributed ledger network to execute the process of the apparatus and this improves the processing efficiency as a whole and reduces various costs required for information processing by the stakeholders. Then, the process of settling the usage fee of the continuous service that substantially starts to be provided after the decease of the contractor can be performed in a form further considering the needs and convenience of the stakeholders and the like.

The settlement management method of the embodiment may be such that the completion of the process of the refunding the money triggers the information processing system to give the notice of the request or permission to freeze the personal account to the predetermined apparatus of the financial institution managing the personal account.

Moreover, the settlement management method of the embodiment may be such that the information processing system executes a process of obtaining the information on the balance or the deposit-withdrawal history of the personal account from the predetermined apparatus of the financial institution managing the personal account and debiting an amount of money equal to the total service usage fee when the balance or the deposit-withdrawal history satisfies the predetermined criterion.

Furthermore, the settlement management method of the embodiment may be such that: the execution entities of at least the process of calculating the service usage fee incurred for the remaining period in the period after the decease and the process of settling the service usage fee calculated for the remaining period and refunding the money among the aforementioned processes are different apparatuses and the apparatuses that are the execution entities form the distributed ledger network together with the predetermined apparatus that is the source of the decease information, and each of the apparatuses that are the execution entities executes the process of receiving a transaction relating to the decease information issued by the predetermined apparatus, the process of storing the transaction in the distributed ledger after the predetermined consensus formation in the distributed ledger network, and either the process of calculating the service usage fee incurred for the remaining period or the process of settling the service usage fee calculated for the remaining period and refunding the money that is to be handled by the apparatus itself.

### REFERENCE SIGNS LIST

1 network
5 distributed ledger network
10 settlement management system
50 smartphone
60 display
100 settlement management apparatus
101 storage device
102 program
103 memory
104 computation device
105 communication device
110 distributed ledger
125 contract information
200 service provider apparatus
201 storage device
202 program
203 memory
204 computation device
205 communication device
225 contract information
226 payment information
300 financial institution server
325 account management information
400 public institution system

1. A settlement management system comprising:
a storage device that stores, for each of contractors of a predetermined service, information on contract contents of the predetermined service in a period in which the contractor is alive and in a period after decease of the contractor;
a computation device that executes
a process of calculating a total service usage fee for a case where a service usage period after decease of a predetermined contractor from a current time point or a predetermined time point is the longest, based on a length of a contract period and a service usage fee unit price in each of the periods indicated in the information on the contract contents,
a predetermined process of balance inquiry for a personal account of the predetermined contractor,
a process of debiting an amount of money equal to the total service usage fee from the personal account to a separate account when a balance of the personal account is an amount of money large enough to settle the total service usage fee,
a process of settling a service usage fee based on the service usage fee unit price in the period in which the predetermined contractor is alive, from the separate account every predetermined period while the predetermined contractor is alive,
a process of obtaining decease information of the predetermined contractor from a predetermined apparatus and calculating a service usage fee incurred for a remaining period in the period after the decease of the predetermined contractor based on a date of decease indicated in the decease information, the length of contract period, and the service usage fee unit price in the period after the decease, and
a process of settling a service usage fee calculated for the remaining period from the separate account and refunding money left after settlement of the total service usage fee to the personal account.

2. The settlement management system according to claim 1, wherein completion of the process of refunding the money triggers the computation device to further give a notice of a request or permission to freeze the personal account to a predetermined apparatus of a financial institution managing the personal account.

3. The settlement management system according to claim 1, wherein the computation device executes a process of obtaining information on a balance or a deposit-withdrawal history of the personal account from a predetermined apparatus of a financial institution managing the personal account and debiting an amount of money equal to the total service usage fee when the balance or the deposit-withdrawal history satisfies a predetermined criterion.

4. The settlement management system according to claim 1, wherein
execution entities of at least the process of calculating the service usage fee incurred for the remaining period in the period after the decease and the process of settling the service usage fee calculated for the remaining period and refunding the money among the processes are different apparatuses and the apparatuses that are the execution entities form a distributed ledger network together with the predetermined apparatus that is a source of the decease information, and
the computation device of each of the apparatuses that are the execution entities executes a process of receiving a transaction relating to the decease information issued by the predetermined apparatus, a process of storing the transaction in a distributed ledger after predetermined consensus formation in the distributed ledger network, and either the process of calculating the service usage fee incurred for the remaining period or the process of settling the service usage fee calculated for the remaining period and refunding the money that is to be handled by the computation device itself.

5. A settlement management method in which an information processing system including a storage device that stores, for each of contractors of a predetermined service, information on contract contents of the predetermined service in a period in which the contractor is alive and in a period after decease of the contractor executes processes comprising:
a process of calculating a total service usage fee for a case where a service usage period after decease of a predetermined contractor from a current time point or a predetermined time point is the longest, based on a length of a contract period and a service usage fee unit price in each of the periods indicated in the information on the contract contents;
a predetermined process of balance inquiry for a personal account of the predetermined contractor;
a process of debiting an amount of money equal to the total service usage fee from the personal account to a separate account when a balance of the personal account is an amount of money large enough to settle the total service usage fee;
a process of settling a service usage fee based on the service usage fee unit price in the period in which the predetermined contractor is alive, from the separate account every predetermined period while the predetermined contractor is alive;
a process of obtaining decease information of the predetermined contractor from a predetermined apparatus and calculating a service usage fee incurred for a remaining period in the period after the decease of the predetermined contractor based on a date of decease indicated in the decease information, the length of the contract period, and the service usage fee unit price in the period after the decease; and
a process of settling a service usage fee calculated for the remaining period from the separate account and refunding money left after settlement of the total service usage fee to the personal account.

6. The settlement management method according to claim 5, wherein completion of the process of refunding the money triggers the information processing system to further give a notice of a request or permission to freeze the personal account to a predetermined apparatus of a financial institution managing the personal account.

7. The settlement management method according to claim 5, wherein the information processing system executes a process of obtaining information on a balance or a deposit-withdrawal history of the personal account from a predetermined apparatus of a financial institution managing the personal account and debiting an amount of money equal to the total service usage fee when the balance or the deposit-withdrawal history satisfies a predetermined criterion.

8. The settlement management method according to claim 5, wherein
execution entities of at least the process of calculating the service usage fee incurred for the remaining period in the period after the decease and the process of settling the service usage fee calculated for the remaining period and refunding the money among the processes are different apparatuses and the apparatuses that are the execution entities form a distributed ledger network together with the predetermined apparatus that is a source of the decease information, and
each of the apparatuses that are the execution entities executes a process of receiving a transaction relating to the decease information issued by the predetermined apparatus, a process of storing the transaction in a distributed ledger after predetermined consensus formation in the distributed ledger network, and either the process of calculating the service usage fee incurred for the remaining period or the process of settling the service usage fee calculated for the remaining period and refunding the money that is to be handled by the apparatus itself.
